(19) United States
(12) Patent Application Publication
(10) Pub. No.: US 2025/0087797 A1
(43) Pub. Date: Mar. 13, 2025

(54) STEEL SHEET FOR TOP COVER OF BATTERY PACK AND ITS MANUFACTURING METHOD

(71) Applicant: ArcelorMittal, Luxembourg (LU)

(72) Inventors: Pascale SANZEY, Laquenexy (FR); Christian ALLELY, Metz (FR); Tarek KRIM, Metz (FR); Laurence DOSDAT, Rozérieulles (FR); Aurélie BESSON, Lironville (FR)

(21) Appl. No.: 18/292,744

(22) PCT Filed: Jun. 24, 2022
(86) PCT No.: PCT/IB2022/055861

§ 371 Date: Jan. 26, 2024

(30) Foreign Application Priority Data
Aug. 2, 2021 (WO) PCT/IB2021/057038

(51) Int. Cl. H01M 50/164; H01M 50/159; H01M 50/16

(52) U.S. Cl. CPC H01M 50/164; H01M 50/159; H01M 50/16

(57) ABSTRACT

A top cover of a battery pack including a metallic coated steel sheet wherein the metallic coating is topped by an organic coating and wherein the organic coating has two layers, the first layer of the organic coating in contact with the metallic coating having a thickness of 2 to 25 μm, and the second layer of the organic coating being based on polyester or polyurethane.

The present invention deals with the housing elements of battery in the car industry. More specifically it relates to a top cover of a battery pack of an electric or hybrid vehicle having good resistance to fire exposure.

### BACKGROUND

Electrical vehicles or hybrid vehicles have to embed at least one heavy and bulky battery pack. This battery pack is made of a plurality of battery modules, each module containing battery cells. Said battery pack must be very well protected against thermal loads that may occur in case of accident, fire or any exposure to high temperature, be it during the assembly or during further life of the vehicle.

### SUMMARY OF THE INVENTION

A current trend is to have bigger and bigger modules and even to store all the battery cells into a battery pack housing while leaving the intermediary containment into modules. The internal architecture of the battery pack can be composed of cells grouped into modules or made of a container directly including the battery cells and closed by a lid. Whatever the internal architecture of the battery pack, it is closed on its top face by an upper cover.

As depicted on FIG. 1, a battery pack comprises from the bottom to the top:
A shield element 1;
An internal architecture of the battery pack including battery cells, and reinforcement parts optionally battery modules 2;
An upper cover also named top cover 3.

The top cover may be adhesively bonded and/or screwed together with other parts of the battery pack. It may also be connected to the internal architecture by any method of assembly such as welding.

Top cover can be made of aluminum sheets, for instance out of a 6000-series aluminum alloy and possibly from the specific AL 6016 alloy.

Fire hazards related to batteries are a major aspect regarding the safety in electric or hybrid vehicles. Especially thermal runaway, once started in one battery cell, produces enough heat to cause adjacent cells to also go into thermal runaway. This produces a fire that repeatedly flares up as each battery cell heats up, breaks, may explode and releases its content. The chemicals inside the battery heat up, which causes further degradation of any enclosures, be it the enclosure of cells, of the modules or of the whole battery pack. The flammable electrolyte can ignite or even explode when exposed to the oxygen in the air.

The top cover of the battery pack being the first separation between the battery cells and the passenger compartment, it is of major importance for fire resistance of battery packs. Top cover must ensure a safe separation between the battery pack and the passenger compartment even at high temperature. The top cover must also release few or no gas when submitted to high temperatures. Especially gases like CO2 or other vaporous combustion products may tremendously increase the pressure inside the battery pack when they are released inside the pack and heated by fire. This may induce opening of the pack, cracks through the housing and explosion.

The patent application US2019/0131602 discloses a housing for battery pack with a top cover. This cover plate is configured as a sandwich comprising at least a metal portion and a plastic portion, and wherein the metal portion is manufactured from at least one of steel and aluminum.

An aim of the present invention is to provide a top cover that has outstanding resistance to fire exposure, including risks of explosion.

The present invention provides a top cover of a battery pack comprising a press stamped metallic coated steel sheet wherein said metallic coating is topped by an organic coating and wherein said organic coating has two layers, the first layer of the organic coating in contact with the metallic coating having a thickness of 2 to 25 μm, and the second layer of the organic coating being based on polyester or polyurethane. Another object of the invention is a battery pack including a top cover according to the invention.

### BRIEF DESCRIPTION OF THE DRAWINGS

Other characteristics and advantages of the invention will become apparent from the following detailed description of the invention.

To illustrate the invention, various embodiments and trials of non-limiting examples will be described, particularly with reference to the following figures:

FIG. 1 illustrates a battery pack and its top cover in an electric battery vehicle,

FIG. 2 illustrates a top cover according to the invention after fire exposure during 130 seconds at a temperature of 1300° C.

FIG. 3 illustrates a top cover not according to the invention after fire exposure during 130 s at 1000° C.

FIG. 4 illustrates a top cover according to the invention after fire exposure during 130 seconds at a temperature of 1000° C.

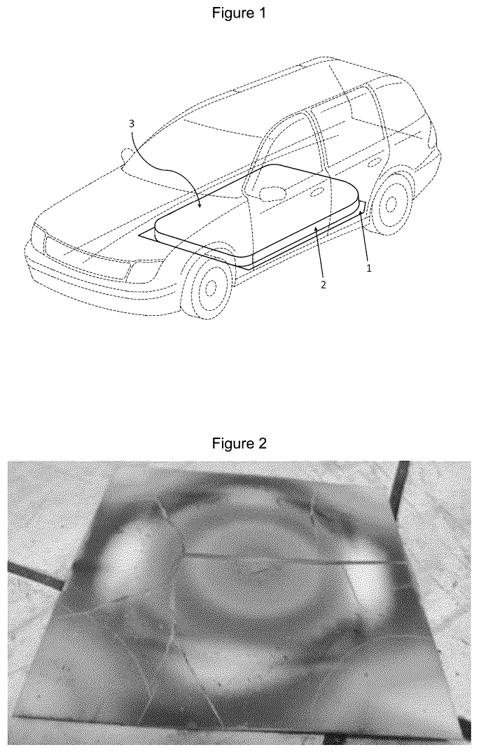

### DETAILED DESCRIPTION

The invention relates to a top cover for battery pack comprising a metallic coated steel sheet wherein said metallic coating is topped by an organic coating.

For this purpose, any steel can be used in the frame of the invention. Preferably, steels having a good formability are well suited. For example, the top cover can be made of mild steel for deep drawing such as Interstitial Free steel having the following weight composition: C≤0.01%; Si≤0.3%; Mn≤1.0%; P≤0.1%; S≤0.025; Al≥0.01%; Ti≤0.12%; Nb≤0.08%; Cu≤0.2%.

For example, the top cover can be made of High Strength Low Alloy (HSLA) steel having the following weight composition: C≤0.1%; Si≤0.5%; Mn≤1.4%; P≤0.04%; S≤0.025%; Al≥0.01%; Ti≤0.15%; Nb≤0.09%; Cu≤0.2%.

The steel sheet can be obtained by hot rolling of a steel slab and subsequent cold rolling of the obtained steel coil, depending on the desired thickness, which can be for example from 0.6 to 1.0 mm.

The steel sheet is then coated with a metallic coating by any coating process. For example, the steel sheet is hot-dip coated in a molten bath and subsequently wiped by air knifes.

The molten bath can be based on zinc and comprise unavoidable impurities.

In a preferred embodiment, the bath is based on zinc and optionally contains 2% by weight of aluminum.

The metallic coating weight can be of 50 to 200 g/m² in total on both sides or less. For example, the coating thickness on the inner side of the battery pack is 10 to 40 μm.

After hot dip metallic coating, the steel sheet is painted, for example on an organic painting line. The surface can be prepared by a degreasing step and a subsequent conversion treatment applied by roll coat to ensure the grip of the 1^{st} layer of paint.

The first layer of paint, also known as primer, can have a thickness of 2 to 25 μm. The primer can be based on different resins such as polyester, polyurethane or epoxy.

The second layer of paint is also applied by roll-coat and is based on polyester or polyurethane. In a preferred embodiment, its thickness is from 2 to 40 μm, preferably from 5 to 25 μm.

The metallic coated steel sheet used in the invention is coated with organic paint. The organic coating used in the invention consists of two layers. The first layer of the organic coating in contact with the metallic coating having a thickness of 2 to 25 μm, and the second layer of the organic coating being based on polyester or polyurethane. The organic coating is then baked in an oven.

Such a coating releases few gasses when submitted to flame temperatures. In case of fire or high temperatures, it won't increase the pressure inside the battery pack.

The metallic and organic coated steel sheet can then be cut into a blank. The blank can be formed by press stamping to the specific shape of the top cover. This specific shape is design related. The top cover being a large horizontal part, it may be subject for vibrations. To reduce these vibrations and subsequent noise, stiffeners are generally punched into the top cover during the stamping operation. Finally, the top cover is attached to the pack by any removable or non-detachable means, for example by screwing, welding or gluing.

### Examples

In order to determine the resistance to fire of the top covers, several tests were performed. All tests were performed on the same test device.

The test device was adapted from the test device described in the Standard ISO 2685:1998. Both following adaptations were done: Firstly, the sample was thermally isolated from the structure of the test device by a 10 mm thick plate of calcium silicate. Secondly, the gas burner generating the flame has been calibrated to achieve the targeted temperature on the face of the sample that is exposed to the flame.

For all tests, the samples have the same dimension of 150×150 mm². Each sample is positioned in front of the gas burner to get hit by the flame. The plate between the sample and the burner has an opening area with the dimension of 90×90 mm².

Three materials were tested:
material 1 is a 0.7 mm thick steel sheet. It is hot-dip galvanized. The metallic coating weight is 275 g/m². It is also organic coated with the following layers on the face exposed to the flame: a 4 μm thick first layer in contact with the metallic coating and an 8 μm thick second layer based on polyester,
material 2 is a 1.0 mm thick aluminum sheet of 6016 series,
material 3 is a 0.8 mm galvanized steel sheet coated with epoxy-based e-coat. The hot-dip coating contains 0.2 of aluminum by weight, the remainder being zinc. The metallic coating weight is 140 g/m². After a phosphating step, the sample was dipped in a e-coating bath. The e-coat tested is Powercron® 6200 HE from supplier PPG. The dry thickness of paint after baking is 25 μm on each face,
material 4 is a 0.7 mm thick steel sheet. It is hot-dip galvanized. The metallic coating weight is 275 g/m². It is also organic coated with the following layers on the face exposed to the flame: a 5 μm thick first layer in contact with the metallic coating and a 20 μm thick second layer based on polyester.

In the following, sample 1 is made of material 1, sample 2 is made of material 2 and sample 3 is made of material 3, sample 4 of material 4.

Two scenarios of fire exposure have been tested. In scenario A, the flame temperature is 1300° C. and the exposure time is 130 s. In scenario B, which is less severe, the flame temperature is 1000° C., and the exposure time is 130 s.

Several criteria are considered for analysis of the tests. The integrity of the sheet, i. e. whether the flame has pierced the sheet or not, the temperature of the face unexposed to the flame (back-face) at the end of the test and the presence of bubbles in the coating after the test. The presence of a bubble shows the release of gas.

TABLE 1
Scenarios of flame exposure

| | Time of flame | Temperature |
|---|---|---|
| Scenario | exposure | of flame |
| A | 130 s | 1300° C. |
| B | 130 s | 1000° C. |

TABLE 2
Scenario A: 130 s at 1300° C.

| Scenario | | Flame | Temparature on | Presence |
|---|---|---|---|---|
| A | Sample | Piercing | back-face after 130 s | of bubbles |
| 1300° C. | 1* | No | 743° C. | No |
| 130 s | 2 | Yes after 45 s | above 910° C. | — |
| | 4* | No | 625° C. | No |

*according to the invention

After an exposure of 130s at 1300° C., the back-face of samples 1 and 4 made of steel remains at a temperature of less than 700° C. and doesn't show any signs of melting. On the contrary, the flame has pierced material 2 made of thicker aluminum.

Moreover, sample 1 doesn't show any bubbles as can be seen on FIG. 2, but only cracks that comes from different thermal expansion between the steel sheet the and organic coating layer. Sample 4 has a similar appearance as sample 1 and doesn't show neither any bubbles.

TABLE 3
Scenario B: 130 s at 1000° C.

| Scenario | | Flame | Temperature on | Presence |
|---|---|---|---|---|
| B | Sample | Piercing | back-face after 130 s | of bubbles |
| 1000° C. | 1* | No | 655° C. | No |
| 130 s | 3 | No | 486° C. | Yes |
| | 4* | No | 585° C. | No |

*according to the invention

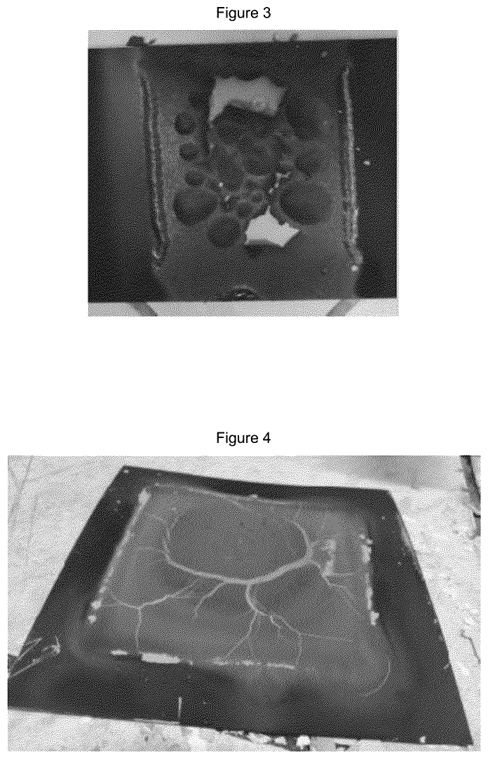

After an exposure of 130 s at 1000° C., the back-face of sample 3 clearly shows bubbles as can be seen on FIG. 3. These open bubbles have released combustion products of the paint in form of gas.

Sample 4 doesn't show any bubbles as can be seen on FIG. 4. Sample 1 has a similar appearance as sample 4 and doesn't show neither any bubbles.

What is claimed is:

1-8. (canceled)

9. A top cover of a battery pack comprising:
a press stamped metallic coated steel sheet including a steel sheet and a metallic coating, the metallic coating being topped by an organic coating having a first layer and a second layer, the first layer of the organic coating being in contact with the metallic coating and having a thickness of 2 to 25 μm, and the second layer of the organic coating being based on polyester or polyurethane.

10. The top cover as recited in claim 9 wherein the metallic coating is based on zinc and optionally comprises up to 2% by weight of aluminium and unavoidable impurities.

11. The top cover as recited in claim 9 wherein the metallic coating has a thickness of 10 to 40 μm on an inner side of the battery pack.

12. The top cover as recited in claim 9 wherein the metallic coated steel sheet has a coating weight of 50 to 200 g/m² in total on both sides.

13. The top cover as recited in claim 9 wherein said first layer of the organic coating in contact with the metallic coating is based on polyester.

14. The top cover as recited in claim 9 wherein the first layer of the organic coating in contact with the metallic coating is based on polyurethane.

15. The top cover as recited in claim 9 wherein the first layer of the organic coating in contact with the metallic coating is based on epoxy.

16. A battery pack comprising the top cover as recited in claim 9.
